(19) United States
(12) Patent Application Publication
(10) Pub. No.: US 2026/0241389 A1
(43) Pub. Date: Aug. 20, 2026

(54) System and Method for Reclaiming and Cleaning Sand

(71) Applicant: McLanahan Corporation, Hollidaysburg, PA (US)

(72) Inventors: Scott C. O'Brien, New Cumberland, PA (US); Mark R. Sell, Woodbury, PA (US); Craig D. Fitzgerald, Duncansville, PA (US)

(21) Appl. No.: 19/543,205

(22) Filed: Feb. 18, 2026

Related U.S. Application Data
(60) Provisional application No. 63/759,794, filed on Feb. 18, 2025.

(51) Int. Cl. B03B 9/00; B03B 5/34; B03B 5/66

(52) U.S. Cl. CPC B03B 9/00; B03B 5/34; B03B 5/66

(57) ABSTRACT

A system for cleaning and reclaiming sand includes at least one pump configured to receive a diluted mixture of manure, sand, and debris from a source of manure and at least one hydrocyclone positioned to receive the mixture from the at least one pump for removing water from the mixture of manure, sand, and debris, and for separating manure solids by specific gravity. The system also includes at least one hydraulic classifier positioned to receive the mixture from an outlet of the at least one hydrocyclone and to process the mixture for separating the sand from other portions of the mixture, thereby providing cleaned and reclaimed sand. A method for cleaning and reclaiming sand using at least one hydrocyclone and at least one hydraulic classifier is also disclosed.

### CROSS REFERENCE TO RELATED APPLICATION

The present application claims the benefit of U.S. Provisional Patent Application No. 63/759,794, filed Feb. 18, 2025, the disclosure of which is hereby incorporated by reference in its entirety.

### BACKGROUND OF THE INVENTION

### Field of the Invention

The present disclosure relates generally to systems and methods for processing manure, such as manure scraped or flushed from a livestock housing for cleaning and reclaiming sand from the manure and, in particular, to systems and methods using a hydraulic classifier, such as a fluidized bed classifier, for separating the sand from other fluids and/or debris in manure.

### Description of Related Art

Livestock housings, such as dairy barns, are designed to allow for efficient manure collection. Manure is either scraped directly from the barn or flushed in some manner, with the dilute manure being collected for processing. For example, barns and similar facilities can include alleys or gutters where manure collects over time. Vehicles, such as tractors or skid-steer loaders, can be equipped with scraper blades or front-end bucket systems to transfer manure accumulated in the alley or gutter to one end of the barn for removal and disposal. Barns can also be flushed for removing manure from the facility. However, with large facilities, which are becoming quite common in modern dairy farming, the quantity of accumulated material can be substantial making it difficult to process collected material in an efficient manner.

One problem which can occur is when manure mixes with livestock bedding material. This often occurs as animals move around their stalls. Sand is often considered to be a “gold standard” material for free-stall bedding providing cows with a comfortable resting surface. Sand contains little or no organic material, which is important to keep bacteria levels low. Dry sand also beneficially wicks moisture away from resting animals and helps to clean hooves and provides good traction on the alleys. However, having sand within the manure mixture makes collecting the manure mixture more difficult and potentially damages machinery. For example, a sand-laden manure mixture has lower flowability and pumpability compared to manure mixtures without sand. Also, the sand is highly abrasive, which can damage pumps and manure collection machinery. In addition, having to continually replace sand, which washes away during manure collection, would increase operating costs requiring frequent replenishment of bedding material.

Accordingly, livestock housing facilities often have systems for collecting or reclaiming sand for reuse as a bedding material. For example, once a manure mixture containing sand is collected, separation and dewatering processes can be performed to minimize machinery damage from the sand-laden mixture and in order to obtain beneficial byproducts, such as reclaimed bedding material. Separation and dewatering processes can use settling basins, mechanical presses, screens, rotary drums, and processes, as well as chemicals, for separating organic and inorganic solids from the animal manure. Efficient manure separation can make waste streams easier to handle, providing longer storage life and more efficient management of different waste streams. Also, bedding material, such as sand, which is cleaned to remove organic material and other solids can be reclaimed and reused or repurposed.

However, while specialized augers and abrasion-resistant pumps are available to reduce harmful effects of sand on machinery, there is a need for improved systems and methods for sand processing and reclamation. In particular, there is a need for systems and methods that reduce amounts of organic matter in the reclaimed sand and also remove debris from manure for improved downstream pumping in an efficient manner. The systems and methods of the present disclosure are provided to address such issues.

### SUMMARY OF THE INVENTION

According to an aspect of the disclosure, a system for cleaning and reclaiming sand includes at least one pump configured to receive a diluted mixture of manure, sand, and debris from a source of manure and at least one hydrocyclone positioned to receive the mixture from the at least one pump for removing water from the mixture of manure, sand, and debris, and for separating manure solids by specific gravity. The system also includes at least one hydraulic classifier positioned to receive the mixture from an outlet of the at least one hydrocyclone and to process the mixture for separating the sand from other portions of the mixture, thereby providing cleaned and reclaimed sand.

According to another aspect of the disclosure, a system for cleaning and reclaiming sand includes at least one pump configured to receive a mixture of manure, sand, and debris from a source of manure and at least one hydraulic classifier that receives the mixture from the at least one pump and processes the mixture for separating the sand from other portions of the mixture, thereby providing cleaned and reclaimed sand. The system also includes at least one pressure sensor configured to measure fluid pressure within a portion of the at least one hydraulic classifier; at least one flow control valve configured to open and close for controlling flow of processing water into the at least one hydraulic classifier; and at least one controller. The at least one controller is configured to receive pressure measurements from the at least one sensor and control flow of the mixture through the at least one flow control valve based, at least in part, on the received pressure measurements.

According to another aspect of the disclosure, a method for cleaning and reclaiming sand, includes the following steps: receiving a manure mixture with water, manure, sand, and debris from a livestock housing; moving the received mixture to an inlet of at least one hydrocyclone using a pump, wherein the hydrocyclone is configured for dewatering and separating particles of the mixture; moving discharge from the at least one hydrocyclone to an inlet of at least one hydraulic classifier; activating the at least one hydraulic classifier to separate sand of a target particle gravity, density, and/or size from other particles and/or debris of the mixture; and moving a slurry including sand from the manure mixture to a dewatering screen for separating water from the slurry, thereby producing an amount of cleaned and reclaimed sand from the manure mixture.

Non-limiting illustrative examples of embodiments of the present disclosure will now be described in the following numbered clauses.

Clause 1: A system for cleaning and reclaiming sand, the system comprising: at least one pump configured to receive a diluted mixture of manure, sand, and debris from a source of manure; at least one hydrocyclone positioned to receive the mixture from the at least one pump for removing water from the mixture of manure, sand, and debris, and for separating manure solids by specific gravity; and at least one hydraulic classifier positioned to receive the mixture from an outlet of the at least one hydrocyclone and to process the mixture for separating the sand from other portions of the mixture, thereby providing cleaned and reclaimed sand.

Clause 2: The system of clause 1, further comprising a sump tank fluidly connected to the at least one pump.

Clause 3: The system of clause 2, further comprising a flow control valve positioned between the at least one pump and the at least one hydrocyclone for controlling flow of the mixture to the at least one hydrocyclone.

Clause 4: The system of clause 2 or clause 3, wherein the at least one pump comprises an adjustable speed drive for controlling flow of the mixture to the at least one hydrocyclone.

Clause 5: The system of any of clauses 2-4, further comprising an outflow port for system effluent configured for expelling excess manure in the sump tank from the system.

Clause 6: The system of any of clauses 1-5, wherein the at least one hydrocyclone comprises a conical housing comprising an inlet, a narrowed outlet, and a separation chamber between the inlet and the narrowed outlet configured for separating particles by size and/or drawing water from the mixture contained in the separation chamber thereby increasing solids concentration of the mixture.

Clause 7: The system of any of clauses 1-6, wherein the at least one hydrocyclone is configured for dewatering the mixture and sizing particles of up to about 9 mm in size.

Clause 8: The system of any of clauses 1-7, wherein the at least one hydrocyclone is configured for dewatering the mixture by a rotating action of the manure.

Clause 9: The system of any of clauses 1-8, wherein the at least one hydraulic classifier is configured to separate the sand from other portions of the mixture based on at least one of size or specific gravity of sand particles.

Clause 10: The system of any of clauses 1-9, wherein the at least one hydraulic classifier comprises a fluidized bed classifier.

Clause 11: The system of clause 10, wherein the fluidized bed classifier is configured to generate a fluidized (teetering) bed of particles of the mixture within a vertical-walled separation chamber enclosed within the fluidized bed classifier.

Clause 12: The system of clause 11, wherein the fluidized bed classifier comprises a process water injection port configured for introducing water below the fluidized bed of particles causing upward rising current for separating larger and/or denser particles from smaller and/or less dense particles within the separation chamber.

Clause 13: The system of clause 12. wherein adjusting a water injection rate through the process water injection port changes a target discharge size, specific gravity, and/or density for the fluidized bed classifier.

Clause 14: The system of clause 12 or clause 13, further comprising a flow meter and flow control valve for controlling the injection of processing water to the at least one fluidized bed classifier.

Clause 15: The system of any of clauses 12-14, further comprising a filter positioned on a water line that provides water to the process water injection port.

Clause 16: The system of clause 15, wherein the filter is configured to provide self or manually operated cleaning.

Clause 17: The system of any of clauses 1-16, wherein the at least one hydraulic classifier comprises a feed-well top portion configured to receive the mixture and a discharge portion for expelling coarser and denser particles from the at least one hydraulic classifier.

Clause 18: The system of any of clauses 1-17, wherein the at least one hydraulic classifier does not include a screen or screen cloth for separation of the sand from the mixture.

Clause 19: The system of any of clauses 1-18, further comprising one or more overflow ports for the at least one hydrocyclone and the at least one hydraulic classifier configured to expel overflow water or manure from the system.

Clause 20: The system of any of clauses 1-19, further comprising at least one dewatering screen configured to receive discharge from the at least one hydraulic classifier and configured to obtain the cleaned and reclaimed sand from the discharge from the at least one hydraulic classifier.

Clause 21: The system of clause 20, wherein water collected from the at least one dewatering screen is collected for further processing.

Clause 22: The system of clause 20 or clause 21, further comprising at least one flow control or underflow valve for limiting flow of the mixture from the at least one hydraulic classifier to the dewatering screen.

Clause 23: The system of clause 22, further comprising at least one second flow control valve for providing processing water to the dewatering screen for hydrating materials passing through the dewatering screen.

Clause 24: The system of any of clauses 1-23, further comprising at least one debris screen or debris grate positioned between the manure source and the at least one pump for removing large or coarse debris from the mixture of manure, sand, and debris prior to passing the mixture through the at least one pump and to the at least one hydrocyclone.

Clause 25: The system of clause 24, further comprising a debris chute for expelling debris captured by the at least one debris screen or debris grate.

Clause 26: The system of any of clauses 1-25, further comprising at least one bypass valve for providing sufficient fluid flow from the at least one pump to the at least one hydrocyclone.

Clause 27: The system of clause 26, further comprising a level sensor configured to measure fluid level at a sump tank of the at least one pump to control the at least one bypass valve based on measurements of the at least one level sensor.

Clause 28: The system of any of clauses 1-27, further comprising at least one flow control valve configured to provide processing water for mixing with the mixture of manure, sand, and debris before the mixture is provided to the at least one pump so that the mixture can be pumped efficiently through the at least one pump and to the at least one hydrocyclone.

Clause 29: The system of any of clauses 1-28, wherein the source of manure comprises manure flushed from livestock housing, such as a barn.

Clause 30: The system of any of clauses 1-29, wherein the source of manure comprises manure scraped from a facility, which is diluted with graywater.

Clause 31: The system of any of clauses 1-30, further comprising a processing water source configured to inject processing water through an inlet to a chamber of the at least one hydraulic classifier, at least one flow control valve configured to control a flow rate for the processing water to the chamber, and at least one system controller configured to operate the at least one flow control valve.

Clause 32: The system of any of clauses 1-31, further comprising at least one pressure sensor configured to measure fluid pressure within the at least one hydraulic classifier.

Clause 33: The system of any of clauses 1-32, further comprising at least one pressure sensor (e.g., a pressure transducer) configured to measure fluid pressure at a sump tank connected to the at least one pump and a bypass valve configured to introduce water at the sump tank based on measured pressure.

Clause 34: The system of any of clauses 1-33, further comprising at least one pressure sensor configured to measure fluid pressure of the mixture at one or more of the following locations of the system: an inflow of the at least one hydrocyclone; an upper location of the at least one hydraulic classifier proximate to an inlet of the at least one hydraulic classifier; a lower location of the at least one hydraulic classifier proximate to a fluidized bed of particles of the at least one hydraulic classifier; or an inflow of the at least one pump.

Clause 35: The system of clause 34, further comprising at least one flow control valve for limiting flow of the mixture through the system, and at least one system controller in communication with the at least one pressure sensor and the at least one flow control valve, wherein the at least one system controller is configured to: receive pressure measurements for fluid in the system from the at least one pressure sensor; and adjust fluid flow through the at least one flow control valve based, at least in part, of the received pressure measurements.

Clause 36: The system of clause 35, wherein the at least one flow control valve is positioned at one or more of the following locations: between the manure source and the at least one pump; at a discharge of the at least one hydraulic classifier; or at a dewatering screen positioned to receive the mixture from the discharge of the at least one hydraulic classifier.

Clause 37: A system for cleaning and reclaiming sand, comprising: at least one pump configured to receive a mixture of manure, sand, and debris from a source of manure; at least one hydraulic classifier that receives the mixture from the at least one pump and processes the mixture for separating the sand from other portions of the mixture, thereby providing cleaned and reclaimed sand; at least one pressure sensor configured to measure fluid pressure within a portion of the at least one hydraulic classifier; at least one flow control valve configured to open and close for controlling flow of processing water into the at least one hydraulic classifier; and at least one controller configured to receive pressure measurements from the at least one pressure sensor and control flow of the mixture through the at least one flow control valve based, at least in part, on the received pressure measurements.

Clause 38: The system of clause 37, wherein the at least one hydraulic classifier is configured to separate the sand from other portions of the mixture based on at least one of size or specific gravity of sand particles.

Clause 39: The system of clause 37 or clause 38, wherein the at least one hydraulic classifier comprises a fluidized bed classifier.

Clause 40: The system of clause 39, wherein the fluidized bed classifier is configured to generate a fluidized (teetering) bed of particles of the mixture within a vertical-walled separation chamber enclosed within the fluidized bed classifier.

Clause 41: The system of clause 39 or clause 40, wherein the fluidized bed classifier comprises a process water injection port configured for introducing the processing water below a fluidized bed of particles in the hydraulic classifier causing upward rising current for separating larger and/or denser particles from smaller and/or less dense particles within a separation chamber.

Clause 42: The system of clause 41, further comprising a filter positioned on a water line that provides water to the process water injection port.

Clause 43: The system of clause 42, wherein the filter is configured to provide self or manually operated cleaning.

Clause 44: The system of any of clauses 41-43. wherein adjusting a water injection rate through the process water injection port changes a target discharge size and/or density for the fluidized bed classifier.

Clause 45: The system of any of clauses 41-44, wherein the fluidized bed classifier further comprises an overflow port configured to expel overflow manure or water from the fluidized bed classifier to a collection vessel.

Clause 46: The system of any of clauses 39-45, further comprising at least one underflow valve configured to control flow of material from a discharge portion of the fluidized bed classifier, and wherein the at least one controller is configured to open or close the underflow valve in order to control a density of a fluidized bed in the fluidized bed classifier and particle size for particles obtained from the fluidized bed classifier.

Clause 47: The system of any of clauses 37-46, further comprising at least one dewatering screen configured to receive discharge from the at least one hydraulic classifier and configured to obtain the cleaned and reclaimed sand from the received discharge.

Clause 48: The system of any of clauses 37-47, further comprising at least one debris screen or debris grate positioned between the manure source and the at least one pump for removing large and/or coarse debris from the mixture of manure prior to passing the mixture through the at least one pump and to the at least one hydrocyclone.

Clause 49: A method for cleaning and reclaiming sand, comprising: receiving a manure mixture comprising water, manure, sand, and debris from a livestock housing; moving the received mixture to an inlet of a hydrocyclone using a pump, wherein the hydrocyclone is configured for dewatering and separating particles of the mixture; moving discharge from the at least one hydrocyclone to an inlet of at least one hydraulic classifier; activating the at least one hydraulic classifier to separate sand of a target particle gravity, density, and/or size from other particles and/or debris of the mixture; and moving a slurry comprising sand from the manure mixture to a dewatering screen for separating water from the slurry, thereby producing an amount of cleaned and reclaimed sand from the manure mixture.

Clause 50: The method of clause 49, wherein the manure mixture is provided from the livestock housing by at least one of scraping or flushing manure from the livestock housing.

Clause 51: The method of clause 49 or clause 50, wherein the at least one hydraulic classifier is configured to separate the sand from other portions of the mixture based on at least one of size or specific gravity of sand particles.

Clause 52: The method of any of clauses 49-51, wherein the at least one hydraulic classifier comprises a fluidized bed classifier and wherein, upon activation, the fluidized bed classifier generates a fluidized (teetering) bed of particles of the mixture within a vertical-walled separation chamber of the fluidized bed classifier.

Clause 53: The method of any of clauses 49-52, further comprising passing the manure mixture through a debris screen or debris grate positioned between the manure source and the pump for removing large and/or coarse debris from the mixture of manure prior to passing the mixture through the pump and to the at least one hydrocyclone.

### BRIEF DESCRIPTION OF THE DRAWINGS

FIG. 1A is a front view of a system for cleaning and reclaiming sand from manure, according to an aspect of the present disclosure;

FIG. 1B is a perspective view of the system of FIG. 1A;

FIG. 2 is a schematic drawing of a system for cleaning and reclaiming sand from manure, according to an aspect of the present disclosure;

FIGS. 3A and 3B show a flow chart for a method for cleaning and reclaiming sand, according to an aspect of the present disclosure;

FIG. 4 is a photograph of an experiment for testing a process for cleaning and reclaiming sand;

FIG. 5 is a photograph comparing sand cleaned using the testing apparatus of FIG. 4 with sand cleaned using another process; and

FIG. 6 is another photograph comparing sand cleaned using the system of the present disclosure with sand cleaned using an existing system.

### DESCRIPTION OF THE INVENTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

With reference to the figures, the present disclosure is directed to systems 10 and methods for cleaning and reclaiming sand by separating and dewatering sand from a semi-fluid manure mixture containing water, manure, sand, and other debris. As described in further detail herein, the manure mixture can be obtained from livestock housing, such as a dairy barn, which uses sand and similar materials for animal bedding. In order to clean and reclaim the sand, non-organic materials including the sand and other particles must be separated from organic matter and other debris so that the sand can be reused or repurposed.

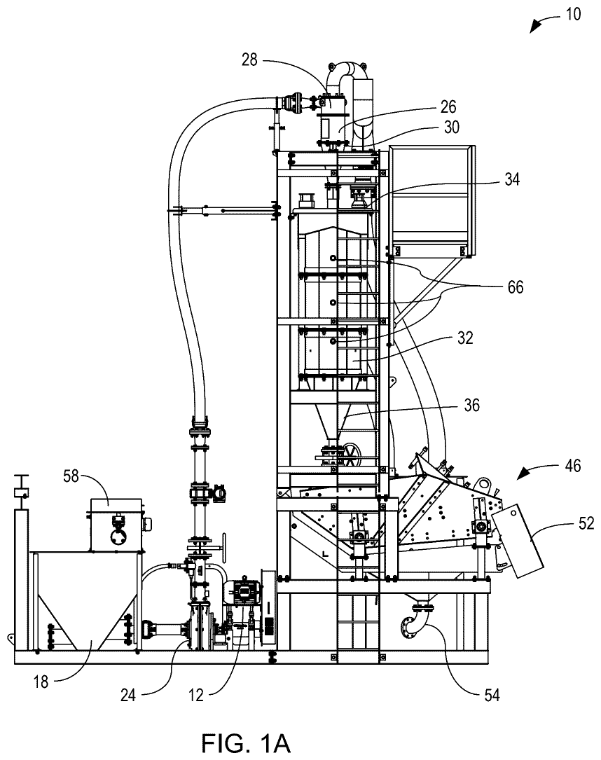

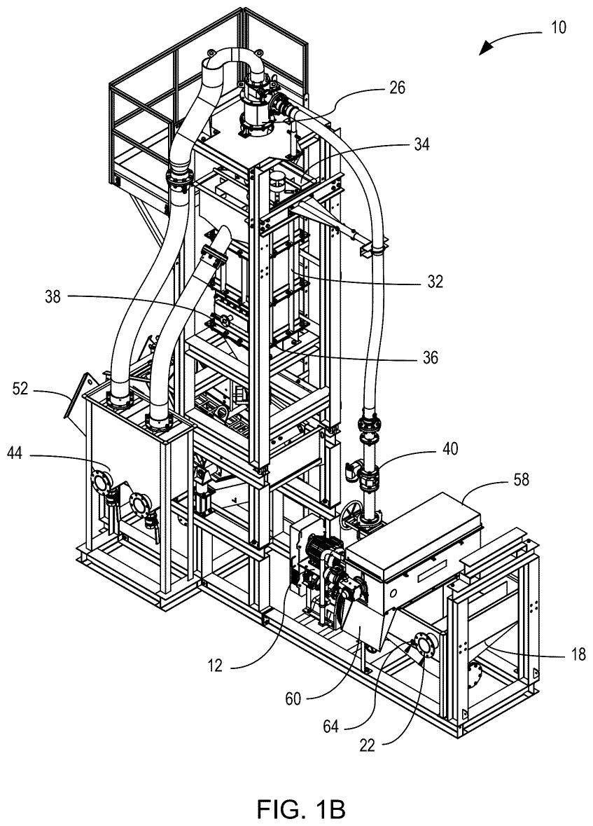

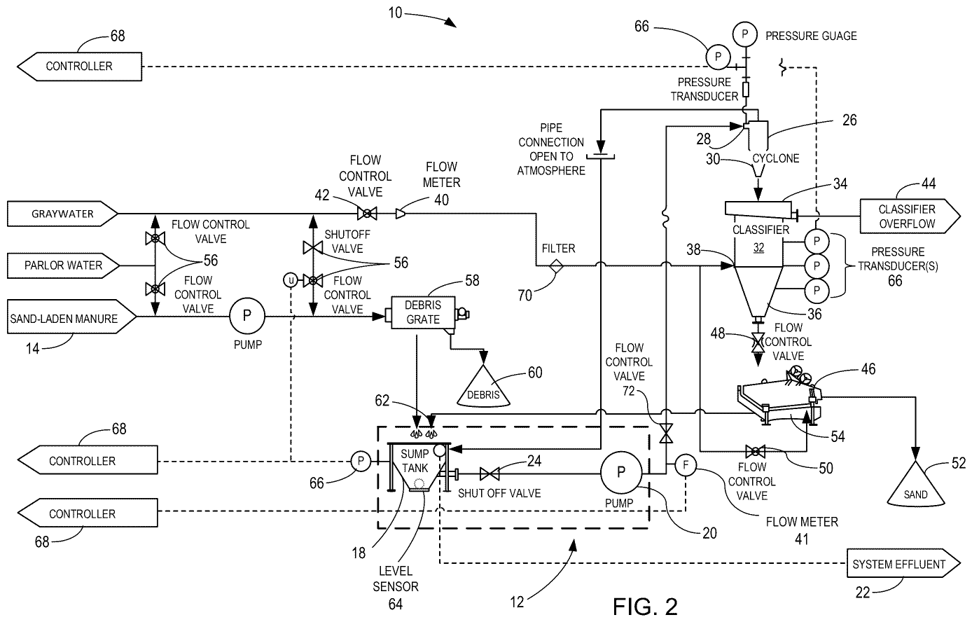

As shown in FIGS. 1A, 1B, and 2, the system 10 for cleaning and reclaiming sand comprises a pump or pump assembly 12 configured to receive the semi-fluid manure mixture of water, manure, sand, and other debris from a manure source 14 (shown in FIG. 2). For example, the manure source 14 can be manure obtained by flushing or scraping manure from a livestock housing, such as a dairy barn. In some examples, the mixture can be processed or pre-treated by adding water to the mixture, passing the mixture through screen(s) or grate(s) for removing large debris, or removing water from the mixture prior to passing the mixture through the pump assembly 12 to improve flowability of the mixture and/or to prevent damage to the pump assembly 12.

In some examples, the pump assembly 12 comprises a sump tank 18 and a pump 20. The pump assembly 12 can also comprise a shut off valve 24, which can be used for performing maintenance for the pump 20. The system 10 can also comprise a system effluent or overflow port 22 for removing manure and/or water from the sump tank 18 before the manure mixture passes to the pump 20. In some examples, the system 10 can further comprise one or multiple flow control valves 72 positioned in system piping before or after the pump assembly 12 for ceasing or restricting a flow rate for the flow of the manure mixture from the manure source 14 to the pump assembly 12 and/or from the pump assembly 12 to the other components and apparatus of the system 10, such as to a downstream hydrocyclone 26 and/or a hydraulic classifier 32 as shown in FIG. 2.

Alternatively or in addition, the pump 20 or pump assembly 12 can comprise a variable speed pump and/or adjustable speed drive for controlling the flow rate for the flow of the manure mixture from the manure source 14 to the pump assembly 12 and/or from the pump assembly 12 to the other components and apparatus of the system 10, such as the hydrocyclone 26 and/or the hydraulic classifier 32. In particular, the variable speed pump and/or adjustable speed drive can be configured to increase power to increase the flow rate of the manure mixture to the hydrocyclone 26 and/or hydraulic classifier 32 or limit or reduce pump power to reduce flow rate of the manure mixture to the downstream components of the system 10.

In some examples, the system 10 optionally further comprises the hydrocyclone 26 for removing water from the manure mixture and/or for sizing particles in the manure mixture. As shown in FIGS. 1A, 1B, and 2, the hydrocyclone 26 can be positioned to receive the manure mixture from the pump assembly 12 through, for example, lengths of system piping extending generally vertically from the pump assembly 12 to an inlet 28 or inflow portion of the hydrocyclone 26. Hydrocyclone separators have been used in industrial processes for dewatering and separating particles for many years and are available from many manufacturers including McLanahan Corp. of Hollidaysburg, PA. In general, the hydrocyclone 26 can be a conical structure having a wide top defining the inlet 28 configured to receive the manure mixture from the pump assembly 12, a narrowed outlet 30 or discharge, and a separation chamber between the inlet 28 and the outlet 30 configured for separating particles by size and/or drawing water from the mixture contained in the chamber thereby increasing solids concentration of the mixture. In addition to dewatering the manure mixture, the hydrocyclone 26 can also remove some particles from the mixture by, for example, sizing particles of up to a predetermine dimension (e.g., up to a maximum size of about 300 μm, or about 9 mm, or within a range of about 5 mm to about 9 mm).

In some examples, the hydrocyclone 26 is selected based on, for example: the feed particle size distribution, which can typically be about 9 mm×0. Other parameters that can be considered include the feed volumetric slurry flow rate; the feed mass flow rate of solids; the feed solids concentration by mass; the particle specific gravities; the specific gravity of the conveying fluid; the viscosity of the conveying fluid; and/or the desired cut size. The cut size can be defined as the particle size that, when subject to classification, has a 50% probability of reporting to the coarse (underflow) stream. In other examples, classification size may be specified by a specific particle size distribution required in the overflow. The hydrocyclone 26 can also be selected based, for example, on the desired overflow solids concentration; the desired underflow concentration; and/or the desired mass split between overflow and underflow. Typical hydrocyclones 26 can be selected to effect cut sizes of 25 microns to 300 microns. Feed ranges can be concentrations of from about 1% solids to about 60% solids by weight for 2.6 to 3.0 specific gravity solids. Conveying fluid is typically 1.0 to 1.05 specific gravity. Hydrocyclones 26 typically have underflow solids concentrations ranging from about 40% solids to about 77% solids by mass at about 2.7 solids specific gravity.

In some examples, the resulting discharge at the outlet 30 of the housing comprises a wet mixture of sand and debris. Alternatively, in systems 10 that do not include a hydrocyclone 26, water and/or other particles can be removed from the manure mixture by other apparatus of the system, such as by vibrating screens, dewatering screens, or a hydraulic classifier.

The system 10 further comprises the hydraulic classifier 32, such as a fluidized bed classifier. The hydraulic classifier 32 can be positioned to receive the manure mixture from the outlet 30 of the hydrocyclone 26. Exemplary hydraulic classifiers 32 or fluidized bed classifiers that can be used with the system 10 of the present discourse are made by a number of manufacturers making devices for use in the construction, mining, and aggregate processing industries including, for example, McLanahan Corp. For example, McLanahan Hydrosizers™ fluidized bed classifiers can be used with the system 10 for providing classification or separation of particles based on particle specific gravity or size. In examples, the hydraulic classifier 32 of the system 10 can be configured to process the manure mixture for precise sizing of sand particles and for separating the sand particles from organic materials and debris remaining in the manure mixture after passing the mixture through, for example, the pump assembly 12 and the hydrocyclone 26. In particular, the hydraulic classifier 32 can be configured to size and separate the sand from other portions of the mixture based on size and/or specific gravity of sand particles. In some examples, particles within a range of about 5 mm to about 9 mm may be discharged through underflow of the hydraulic classifier 32 at solids concentrations from about 60% to about 82% by weight when processing 2.7 specific gravity solids.

In some examples, the hydraulic classifier 32 comprises a feed-well top portion 34 configured to receive the manure mixture from the pump assembly 12 or hydrocyclone 26 and a discharge portion 36 for expelling coarser and denser particles of the sand from the hydraulic classifier 32 for reclaiming these coarser and/or denser sand particles. More particularly, in examples, the hydraulic classifier 32 is an apparatus configured to separate particles by size or specific gravity without using screens or grates, which are commonly used by other separator devices. Instead, the hydraulic classifier 32 or fluidized bed classifier can be configured to generate a fluidized or teetering bed of particles within a vertical-walled separation chamber enclosed within the hydraulic classifier 32. The hydraulic classifier 32 then separates particles based on which materials can pass through the fluidized bed in the separation chamber of the hydraulic classifier 32 and those that cannot pass through the fluidized bed.

The fluidized bed is supported by water injected into the hydraulic classifier 32 below the fluidized bed through a process water injection inlet or port 38. For example, fluidization or teeter water can be injected for the hydraulic classifier 32 at rates for about 2 gpm to about 20 gpm per square foot of hydrosizer surface area determined based, for example, on a configuration and size of the hydraulic classifier 32. The injected process water causes upward rising current for separating the larger and/or denser particles from the smaller and/or less dense particles within the separation chamber of the hydraulic classifier 32. In particular, the larger and/or denser particles can easily pass through the fluidized bed toward the discharge portion 36 of the hydraulic classifier 32. By contrast, the smaller and/or less dense particles remain above the fluidized bed and can be drawn away from the hydraulic classifier 32 as overflow. Particles that are a similar size to particles forming the fluidized bed can remain in the separation chamber for a period of time until particles within a tightly defined target range eventually pass through the fluidized bed towards the discharge portion 36. Particles that are slightly smaller and/or less dense than the target range do not pass through the fluidized bed and are eventually expelled from the separation chamber with the overflow liquid. Because particles can remain in the hydraulic classifier 32 proximate to the fluidized bed, particle classification can be precise with particles that are only slightly larger and/or denser than particles of the fluidized bed eventually passing to the discharge portion 36 and other particles remaining above the fluidized bed and expelled as overflow.

As will be appreciated by those skilled in the art, the target particle discharge size for the hydraulic classifier 32 is controlled based, at least in part, on the injection pressure or flow rate of the processing water injected into the hydraulic classifier 32 through the process water injection port 38. As the uplifting force of the injected process water changes, the density of the fluidized bed can also change, allowing different sized particles to pass through the fluidized bed for cleaning and/or reclaiming particles of different sizes. As described in further detail herein, the process water injection pressure/flow rate can be manually adjusted by a system operator or automatically controlled by a system controller, such as a computing device or computer processor. For example, the system 10 can comprise a flow control valve 42 in process water piping attached to the process water injection port 38 for monitoring and adjusting a flow rate at which processing water is injected into the separation chamber of the hydraulic classifier 32. The flow control valve 42 can be configured to be manually or automatically opened, closed, or adjusted to change flow rate in order to modify or control the target discharge size and/or density for particles passing through the hydraulic classifier 32 to the discharge portion 36.

Depending on quality of water available for fluidization, in some examples, the system 10 can further comprise a filter 70, such as a self or manually operated cleaning filter, disposed in the process water piping for filtering water provided to the process water injection port 38 and hydraulic classifier 32. The filter 70 can be configured to remove some or all suspended solids from graywater prior to entering the hydraulic classifier 32. More particularly, as shown in FIG. 2, the filter 70 can be positioned in the process water piping between the flow meter 40 and the process water injection port 38 for filtering the process water before it enters the hydraulic classifier 32. In other examples, the filter 70 can be positioned at other upstream locations, such as upstream of the fluid control valve 42 or at other convenient locations in the process water piping.

In some examples, the hydrocyclone 26 and/or hydraulic classifier 32 can further comprise overflow ports 44 configured to expel overflow manure and/or water from the hydrocyclone 26 and hydraulic classifier 32. Overflow water or manure expelled through the overflow ports 44 can be directed to a collection vessel or reservoir for further processing. In some examples, expelled overflow water can be filtered to remove solids and then directed to a water circuit for re-injecting water into the system 10 (e.g., through the process water injection port 38 of the hydraulic classifier 32) when required. In some examples, the system 10 may need to recover the manure that is in the overflow of the hydraulic classifier 32. For example, overflow manure can be directed to a sieve bend, an independent dewatering screen, or be dewatered by some other agricultural device.

In some examples, the system 10 can further comprise a dewatering screen 46 positioned to receive discharge from the discharge portion 36 of the hydraulic classifier 32. Exemplary dewatering screens 46 that can be used with the system 10 of the present disclosure are manufactured by McLanahan Corp., as well as other manufacturers. Dewatering screens are typically outfitted with fine aperture urethane or stainless steel decks. The apertures can be as small as 0.125 mm but are typically 0.3 mm by 12 mm slots. The low open area of these decks greatly reduces the probability of a particle passing through the decks particularly because the screens are sized to promote a thick material bed level. This thick layer of solids acts as an autogenous filter media and traps fines as they are carried with the bed to the discharge oversize of the screen. Silica sand at 2.65 specific gravity may be as dry as 90% solids by weight, largely depending upon the particle size distribution. Fine particle size distributions, due to the increase in surface area, may exit the screen at 80% solids by weight.

As shown in FIG. 2, the dewatering screen 46 can be positioned below the discharge portion 36 of the hydraulic classifier 32, such that portions of the mixture discharged from the hydraulic classifier 32 pass to the dewatering screen 46 by gravity. The dewatering screen 46 can be configured to remove water from the discharged mixture in order to separate and dry the sand in the mixture, thereby providing cleaned and reclaimed sand. Fluids separated from the mixture by the dewatering screen 46 can be collected for further manure processing or disposal. In some examples, the dewatering screen 46 comprises a vibrating device including screen media configured to receive a slurry material from the hydraulic classifier 32. As the screen media vibrates, solids move upward and forward along the screen media, while water passes through openings in the screen media to an underflow pan, thereby providing dewatered solids. Dewatered solids, such as cleaned sand, pass through an outlet or discharge portion of the dewatering screen 46 at an end of the screen media opposite where the slurry material is received. The dewatered solids, such as the cleaned sand, can then be discharged from the dewatering screen 46 and system 10 through a clean sand discharge chute 52 for expelling the cleaned sand from the system 10 and, for example, to a collection container or location. Process water from the dewatering screen 46 can be flushed from the underside pan toward a discharge portion or port 54.

In some examples, flow of the discharged mixture and processing water to the dewatering screen 46 can be controlled by one or multiple flow valves 48, 50 disposed in piping of the system 10. For example, the system 10 can comprise a flow control valve 48 for limiting flow of the manure mixture from the discharge portion 36 of the hydraulic classifier 32 to the dewatering screen 46. The system 10 can also include another flow control valve 50 for providing water to the dewatering screen 46 for hydrating materials passing through the dewatering screen 46, so that the material can pass along the screen media as described above. In particular, water can be introduced to an underpan of the dewatering screen 46 to ensure that any material in the pan is flushed away to, for example, a collection vessel, such as the sump tank 18.

In some examples, the system 10 can further comprise apparatus for preparing the manure mixture for processing prior to introducing the manure mixture to a separation apparatus, such as the hydrocyclone 26 and/or hydraulic classifier 32. For examples, as shown in FIG. 2, the system 10 can include shut-off and/or flow control valves 56 and piping for introducing graywater (e.g., relatively clean wastewater without larger or coarse particles that are unsuitable for use in the system 10) to the mixture to dilute the manure mixture allowing the mixture to pass more easily through the system 10. In some examples, initially preparing the manure mixture can include removing large or coarse particles, such as particles larger than about 12 mm, from the mixture prior to, for example, providing the mixture to the pump assembly 12. Alternatively or in addition, the hydraulic classifier 32 can be programmed to fully open an underflow valve according, for example, to a timed sequence, to discharge coarser material, such as for expelling materials up to about 9 mm. However, it is understood that these coarser particle limits should not be construed as typical feed for the hydraulic classifier 32 and should be avoided in all cases.

As previously described, it may be especially necessary to introduce additional water to the manure mixture when the manure is scraped from the livestock housing or barn. When the manure is flushed from the barn, the resulting manure mixture is often in a liquid or semi-liquid state meaning that adding graywater to the mixture may not be necessary. However, in some instances, adding additional graywater to semi-liquid mixtures may be helpful, ensuring that the mixture moves freely through pipes and other apparatus of the system 10.

In some examples, the system 10 can further comprise a debris screen 58 or debris grate positioned between the manure source 14 and the pump assembly 12 for removing large or coarse debris from the mixture of manure prior to passing the mixture through the pump assembly 12 and to the hydrocyclone 26 or hydraulic classifier 32. In some examples, the debris screen 58 can be a non-vibratory rotary drum with apertures of about 12 mm to 20 mm or preferably about 19 mm. In some examples, as shown in FIGS. 1A and 1B, the debris screen 58 can be coupled to a debris chute 60 for expelling larger debris captured by the debris screen 58.

As previously described, the system 10 can further comprise one or multiple shut off or flow control valves 42, 48, 50, 56, 72 positioned throughout the system 10 for controlling both movement of the manure mixture through the system 10 and for introducing processing or graywater to various apparatus of the system 10. In some examples, as shown in FIG. 2, the system 10 further comprises a gravity line 62 for introducing additional water to the mixture at the pump assembly 12 to improve flow. As previously described, adding additional water to the manure mixture can ensure that the mixture moves efficiently through the pump assembly 12 and into the separation apparatus, such as the hydrocyclone 26 and/or hydraulic classifier 32. The system 10 can also comprise the flow valve 42 configured to control a flow rate for the processing water that passes through the filter 70 and is injected into the hydraulic classifier 32 through the injection port 38. In other examples, the system 10 can comprise flow control valves 42, 48, 50, 56, 72 at one or more of the following locations: between the manure source 14 and the pump assembly 12; at a discharge portion 36 of the hydraulic classifier 32; or at the dewatering screen 46 positioned to receive the mixture from the discharge portion 36 of the hydraulic classifier 32.

The system 10 can also include sensors (e.g., piezoelectric, bubble tube, and/or diaphragm sensors) for monitoring flow of liquids and/or flow of the manure mixture through the system 10. For example, as shown in FIG. 2, the system 10 can comprise a level sensor 64 configured to measure fluid level at the pump assembly 12. In some examples, measurements obtained by the level sensor 64 can be used to control the flow control values 42, 48, 50, 56 in order to adjust and/or cease a flow of liquid (e.g., graywater) to the manure mixture stored, for example, in the sump tank 18 of the pump assembly 12. In some examples, the level sensor 64 can comprise capacitance probes, ultrasonic level sensors, and radar (both free flight and guided) level sensors for determining a fluid level of the sump tank 18. In other examples, fluid level can be determined by other optical, motion, or force sensors as are known in the art.

In some examples, the system 10 further comprises pressure sensors 66 and/or differential pressure sensors positioned throughout the system 10 for monitoring fluid flow through the system 10. For example, the system 10 can comprise a pressure sensor 66 for measuring fluid pressure of the mixture at locations including at an inflow of the pump 20, an inflow 28 and/or outflow 30 of the hydrocyclone 26, an inflow 34 of the hydraulic classifier 32, within a separation chamber of the hydraulic classifier 32, or at the discharge portion 36 of the hydraulic classifier 32. In some examples, the hydraulic classifier 32 can comprise multiple pressure sensors 66 for measuring fluid pressure at different locations within the separation chamber of the hydraulic classifier 32. For example, the system 10 can comprise pressure sensors 66 or transducers positioned to measure fluid pressure at locations including an upper location of the hydraulic classifier 32 near the inflow 34 and/or a lower location of the hydraulic classifier 32 proximate to the fluidized bed. The system 10 can also comprise a pressure sensor 66 at an intermediate location between the inflow 34 and the fluidized bed. These pressure sensors 66 may be mounted flush on the wall of the hydraulic classifier 32 or at some distance between the wall and center of the hydraulic classifier tank. In some examples, the system 10 can further comprise one or more load cells to measure changes in the mass of the tank contents. In some examples, however, multiple pressure sensors 66 can be used to monitor more defined sections of the fluidized bed. In some examples, the hydraulic classifier 32 may only include pressure sensors 66 at two locations (e.g., upper and lower locations) instead of all three locations. In some examples, a pressure sensor 66 at a third location (e.g., the intermediate location) can be used solely for providing options for extra adjustment for operating parameters of the hydraulic classifier 32 rather than for monitoring pressure or fluid flow through the hydraulic classifier 32.

As previously described, the system 10 can be configured to operate manually based on input received from a system user. For example, the system 10 user can manually open or close various flow control valves 42, 48, 50, 56, 72 of the system 10 for reducing or increasing flow rate for the manure mixture through the system 10. The user can also adjust a flow rate for the processing water being injected into the separation chamber of the hydraulic classifier 32 for changing particle size which can pass through the fluidized bed and to the discharge portion 36 of the hydraulic classifier 32.

In some examples, as shown in FIG. 2, the system 10 can alternatively or additionally include a system controller 68, such as a computing device or computer processor, in wired or wireless communication with the sensors 64, 66 and flow control valves 42, 48, 50, 56, 72 for automatically controlling fluid flow through the system 10. The controller 68 can be configured to receive (e.g., periodically or continually receive) sensor readings from the sensors 64, 66 and emit instructions to the flow control valves 42, 48, 50, 56, 72 causing one or more of the flow control valves 42, 48, 50, 56 to open or close for introducing or removing fluid from the system 10. For example, the system controller 68 can be configured to operate the flow control valve(s) 42, 48, 50, 56 to introduce additional processing water to the sump tank 18 or between the sump tank 18 and pump 20 based on measurements from the level sensor 64 or a pressure sensor 66 associated with the sump tank 18 or pump 20. In one example, when the level sensor 64 indicates that fluid level in the sump tank 18 is low, the system controller 68 can cause the flow control valve(s) 42, 48, 50, 56 to open allowing additional water to enter the sump tank 18 increasing flowability of the manure mixture contained therein. In other examples, the system controller 68 can receive pressure measurement from a pressure sensor 66 located proximate to the pump assembly 12 indicating a flow rate for the manure mixture passing from the pump assembly 12 to the hydrocyclone 26 or hydraulic classifier 32. The system controller 68 can be configured to open the flow control valve(s) 42, 48, 50, 56 introducing additional water to the manure mixture in order to allow the mixture to flow more easily through the system 10. In other examples, the system controller 68 can be configured to cause the pump 20 to turn off when measurements from the level sensor 64 or pressure sensor 66 indicate that the water level in the sump tank 18 is low, meaning that not enough manure mixture is available for processing. In other examples, the system controller 68 can be configured to open, close, or adjust a flow control valve 42 for introducing the processing water the to the hydraulic classifier 32.

In some examples, the system controller 68 can operate the hydraulic classifier 32 to control a target particle gravity, density, and/or size for the hydraulic classifier 32 as follows. Control of the hydraulic classifier 32 to provide particles of a particular target size can be achieved by monitoring and controlling two process conditions, namely water flow rate (e.g., for water injected into the hydraulic classifier 32 through the process water injection port 38) and teeter bed density. In some examples, the teeter water flow rate can be set commensurate with the hindered settling velocities of solids that are near the required size of separation. Bed density is used to control the hindered settling environment such that when combined with the rising current of teeter water, an acceptable size classification or density of separation is obtained.

Teeter water flow rate for process water injected into the hydraulic classifier 32 is controlled through the use of the flow control valve 42 on the injection water piping. This flow control valve 42 can be manually adjusted or automatically actuated based, for example, on output from inline flow meters 40, 41 and controlled by the system controller 68. For example, the system 10 can comprise a flow meter 40 configured to monitor teeter water to the hydraulic classifier 32 and/or a flow meter 41 that monitors flow to the hydrocyclone 26. In some examples, the inline flow meters 40, 41 can comprise one or more of the following sensors: magnetic, Coriolis, ultrasonic, differential pressure (pitot tube), or mechanical sensors. It is noted that differential pressure sensors and mechanical sensors may require using processing water without any appreciable entrained solids. Sensors using magnetic, Coriolis, or ultrasonic technologies can be used with processing water including entrained solids.

The teeter or fluidized bed in the separation chamber of the hydraulic classifier 32 is comprised of solid particles that accumulate in the hydraulic classifier 32 autogenously from the incoming feed. Maintenance of the teeter or fluidized bed is accomplished by monitoring bed density and adjusting flow with a flow control or underflow valve 48 at the discharge portion 36 of the hydraulic classifier 32 when the bed density is above or below a density sufficient to provide desired particle size. More particularly, the system controller 68 can be configured to implement a feedback loop (e.g., a stand-alone PID Loop controller or PLC based PID loop logic) to operate the underflow valve 48 based on error reported in a comparison between a process value and a density setpoint for the fluidized bed. The system controller 68 can be configured to determine a position or status for the underflow valve 48 based on the detected error and resulting comparison. In particular, if it is determined that the bed density exceeds a set point, the system controller 68 can be configured to cause the underflow valve 48 to open or increase flow through the underflow valve 48. By contrast, if the determined bed density is less than a setpoint, the system controller 68 can cause the underflow valve 48 to close or reduce flow from the discharge portion 36 of the hydraulic classifier 32 causing bed density to increase. In some examples, the underflow valve 48 can be configured to permit fluid flow from the hydraulic classifier 32 according to a predetermined pattern. For example, the underflow valve 48 can release fluid from the hydraulic classifier 32 according to a pulsed (on/off) pattern, a modulating discharge pattern, or a pattern including a combination of pulses and modulations.

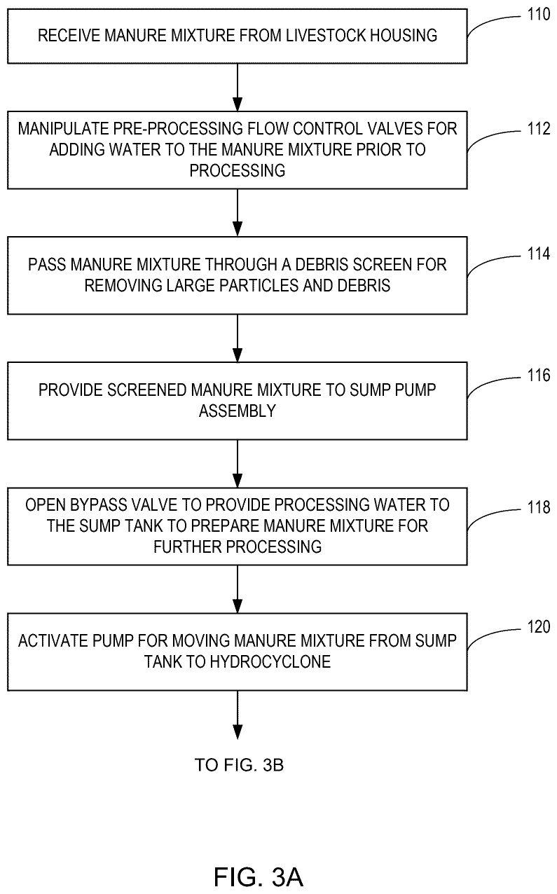

The system shown in FIGS. 1A, 1B, and 2 is used in processes for cleaning and reclaiming sand from manure, such as manure collected from a barn or another livestock housing. FIGS. 3A and 3B show a flow chart providing steps of a method for processing the manure to obtain the cleaned and reclaimed sand. As previously described, in some examples, this method can be manually controlled. For example, a system operator can turn on or off different apparatus of the system 10, open or close flow control valves 42, 48, 50, 56, 72 and/or monitor sensor 64, 66 measurements in order to control sizing for the reclaimed sand and/or to control liquid flow to and from the system 10. In other examples, system apparatus and control valves 42, 48, 50, 56, 72 can be operated automatically by the system controller 68, which can be configured to receive measurement data detected by sensors 64, 66 positioned throughout the system 10 and control system apparatus and/or open, close, or control fluid control valves 42, 48, 50, 56, 72 based on the received measurement data.

In some examples, the method comprises a step 110 of receiving the manure mixture comprising the water, manure, sand, and other debris from the manure source 14, such as sand-laden manure received from livestock housing. In some examples, as shown in FIG. 2, the manure mixture is drawn into a sand cleaning and reclaiming system 10 by one or more pumps in line between the manure source 14 and other parts of the system 10. At step 112, the method can further comprise opening or closing one or more pre-processing flow control valves 56 for adding water to the manure mixture prior to processing to improve flowability.

At step 114, the method further comprises passing the manure mixture through the debris screen 58 for removing large and/or coarse particles (e.g., particles larger than about 10 mm to about 15 mm) and debris from the manure mixture. Large and/or coarse particles and debris captured by the debris screen 58 can be removed from the system 10 through a debris chute 60. After processing by the debris screen 58, at step 116, the screened manure mixture is then provided to the pump assembly 12. For example, the manure mixture can be transported to the sump tank 18 by gravity. Optionally, at step 118, one or more of the flow control valve(s) 42, 48, 50, 56 can be opened to provide processing water to the sump tank 18 if the manure mixture is too dry for further processing.

At step 120, once the manure mixture is in condition for further processing, the pump 20 can be activated and/or the flow control valve 72 can be opened for drawing the manure mixture from the sump tank 18 to the inlet 28 of the hydrocyclone 26. For example, as previously described, the pump 20 can propel the manure mixture through vertically oriented pipe segments to the inlet 28 of the hydrocyclone 26. In some examples, the pump 20 can be a variable speed pump or comprise an adjustable speed drive for controlling flow rate of the manure mixture as it is moved through the vertically oriented pipe segment(s) and from the sump tank 18 to the inlet 28. At step 122, the manure mixture is then processed by the hydrocyclone 26 for dewatering and separating particles of the manure mixture.

At step 124, discharge from the outlet 30 of the hydrocyclone 26 is introduced to the hydraulic classifier 32 for further processing. As previously described, the fluidized bed in the separation chamber of the hydraulic classifier 32 is maintained in order for the hydraulic classifier 32 to produce particles of a desired size or specific gravity. In particular, density of the fluidized bed can be modified by adjusting either flow rate for processing water injected to the hydraulic classifier 32 through the process water injection port 38 and/or by adjusting flow through the flow control valve or underflow valve 48 at the discharge portion 36 of the hydraulic classifier 32. In particular, at steps 126a, 126b, optionally a system operator or automated system controller can open, close, or adjust fluid flow through the flow control valve 42 for the process water and/or the underflow valve 48 for the hydraulic classifier 32 based, for example, on a comparison between the fluidized or teeter bed density and a target product value to ensure that particles of a desired size are obtained from the hydraulic classifier 32.

At step 128, the method further comprises passing the mixture from the hydraulic classifier 32 to the dewatering screen 46, which is configured to separate water from the sand, thereby providing dry clean and reclaimed sand as shown in FIG. 2. More specifically, the mixture comprising the sand can pass from the discharge portion 36 of the hydraulic classifier 32 to the dewatering screen 46 by gravity. As previously described, the dewatering screen 46 vibrates causing water to pass through apertures or openings in the screen media. Dewatered sand is then provided from the dewatering screen 46 through a clean sand discharge chute 52, while collected water and any remaining organic materials can pass from the dewatering screen 46 through the discharge port 54. The water and remaining organic particles can undergo additional manure processing and/or can be collected in an overflow container or reservoir.

While examples of the systems and methods for cleaning and reclaiming sand of the present disclosure are shown in the accompanying figures and described hereinabove in detail, other examples will be apparent to, and readily made by, those skilled in the art without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

### Examples

To evaluate the manure processing methods disclosed herein, the present inventors have constructed prototype manure processing devices and performed testing to evaluate quality of sand obtained using the disclosed methods. An explanation of testing performed using the prototype devices follows.

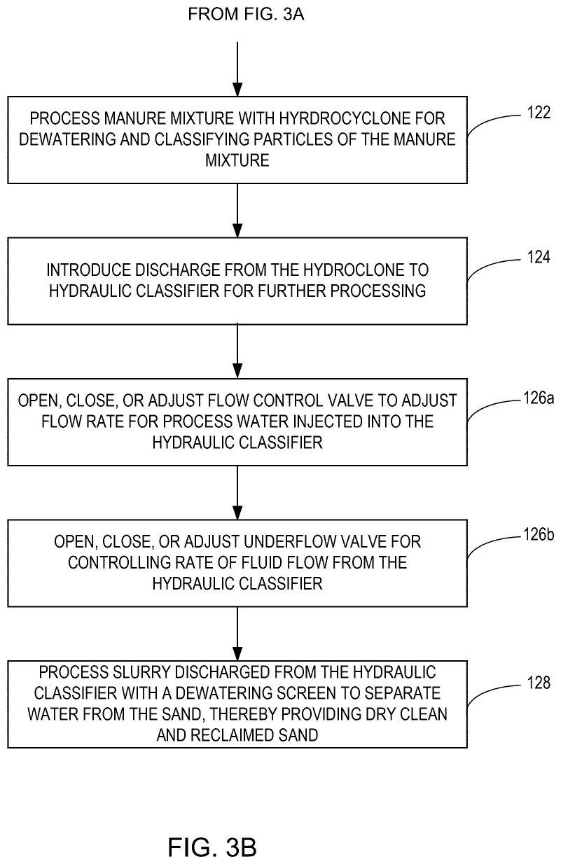

FIG. 4 is a photograph of the prototype device 210, which includes a small-scale hydraulic classifier 212 including an inlet 214 and outlet 216. The hydraulic classifier 212 also includes a processing water inlet port 218 for introducing processing water below the fluidized bed generated in the separation chamber of the hydraulic classifier 212. In order to test manure processing ability of the hydraulic classifier 212, a semi-fluid manure mixture including sand was introduced through the inlet 214. The manure mixture was processed by the hydraulic classifier 212 providing a slurry of sand particles at the outlet 216 or discharge portion of the hydraulic classifier 212. The sand slurry was collected and dried to produce reclaimed sand from the manure mixture.

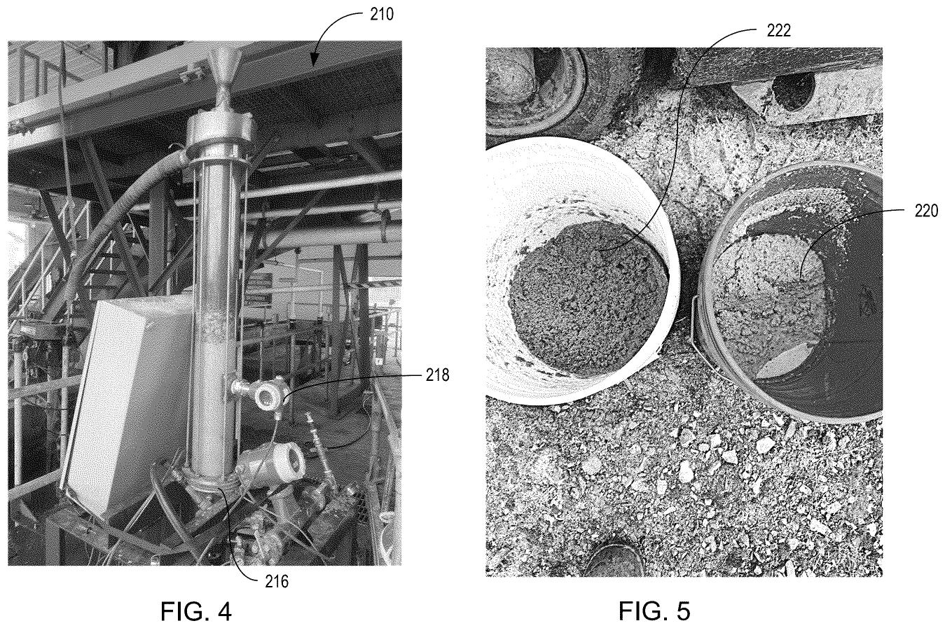

FIG. 5 is a photograph showing reclaimed sand 220 obtained by the hydraulic classifier 212 using the methods of the present disclosure. The reclaimed sand 220 was compared to sand 222 obtained from manure using other processing techniques. The reclaimed sand 220 obtained from the hydraulic classifier 212 using the method of the present disclosure was found to be lighter in color and contained less organic material than sand obtained from manure using other processing methods.

A full-scale prototype of the system 10 disclosed herein was also constructed in order to perform additional testing. The full scale prototype includes the features shown in FIGS. 1A, 1B, and 2, including the hydrocyclone 26 and hydraulic classifier 32, specifically a fluidized bed classifier by McLanahan Corp. Sand samples were collected from the outflow of the dewatering screen 46, as previously described. Sand samples were also collected from an existing McLanahan Sand-Manure Separator installed at the same location which includes an auger moving at slow speed for moving manure laden sand through a closed loop rinsing system.

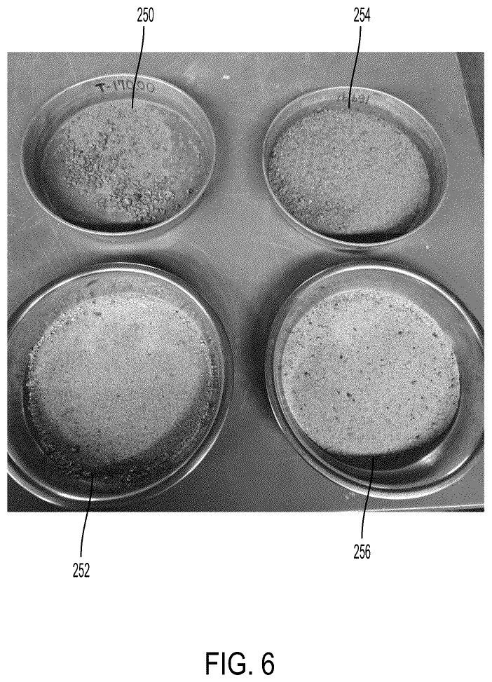

FIG. 6 is a photograph of the sand samples 250, 252, 254, 256 collected by the system 10 comprising the hydrocyclone 26 and fluidized bed classifier of the present disclosure and samples collected from the existing McLanahan system. Specifically, the samples 250, 252 on the left side of FIG. 6 are both from the existing McLanahan Sand-Manure Separator. The samples 254, 256 on the right side of FIG. 6 are from the system 10 of the present disclosure. The two samples 250, 254 at the top of FIG. 6 represent sand as collected. The samples 252, 256 on the bottom of the FIG. 6 photograph show sand that was run through a furnace to drive off organics.

Visually, it can be seen that the sand collected from the existing McLanahan Sand-Manure Separator system includes clumps of organics, while the sand samples collected from the prototype system 10 of the present disclosure are much cleaner. After incinerating the organics, the inventors were able to validate the conclusion that the system 10 disclosed herein provides cleaner sand. Specifically, it was determined that incineration removed 17.39 grams of organics from a 257.23-gram sample (6.76% organic material) of sand obtained from the existing McLanahan Sand-Manure Separator system. By contrast, it was determined that incineration removed only 1.97 grams of organics from a 203.56-gram sample (0.97% organic material) obtained from the prototype system 10 disclosed herein. Based on these results, the inventors conclude that the system 10 disclosed herein produces sand that is cleaner and has less organic material than sand cleaned using an existing Sand-Manure Separator system.

What is claimed is:

1. A system for cleaning and reclaiming sand, the system comprising:
at least one pump configured to receive a diluted mixture of manure, sand, and debris from a source of manure;
at least one hydrocyclone positioned to receive the mixture from the at least one pump for removing water from the mixture of manure, sand, and debris, and for separating manure solids by specific gravity; and
at least one hydraulic classifier positioned to receive the mixture from an outlet of the at least one hydrocyclone and to process the mixture for separating the sand from other portions of the mixture, thereby providing cleaned and reclaimed sand.

2. The system of claim 1, further comprising a sump tank fluidly connected to the at least one pump.

3. The system of claim 2, further comprising a flow control valve positioned between the at least one pump and the at least one hydrocyclone for controlling flow of the mixture to the at least one hydrocyclone.

4. The system of claim 2, further comprising an outflow port for system effluent configured for expelling excess manure in the sump tank from the system.

5. The system of claim 1, wherein the at least one hydrocyclone comprises a conical housing comprising an inlet, a narrowed outlet, and a separation chamber between the inlet and the narrowed outlet configured for separating particles by size and/or drawing water from the mixture contained in the separation chamber thereby increasing solids concentration of the mixture.

6. The system of claim 1, wherein the at least one hydraulic classifier is configured to separate the sand from other portions of the mixture based on at least one of size or specific gravity of sand particles.

7. The system of claim 1, wherein the at least one hydraulic classifier comprises a fluidized bed classifier configured to generate a fluidized bed of particles of the mixture within a vertical-walled separation chamber enclosed within the fluidized bed classifier.

8. The system of claim 7, wherein the fluidized bed classifier comprises a process water injection port configured for introducing water below the fluidized bed of particles causing upward rising current for separating larger and/or denser particles from smaller and/or less dense particles within the separation chamber.

9. The system of claim 8, further comprising a flow meter and flow control valve for controlling the injection of processing water to the fluidized bed classifier.

10. The system of claim 1, wherein the at least one hydraulic classifier comprises a feed-well top portion configured to receive the mixture and a discharge portion for expelling coarser and denser particles from the at least one hydraulic classifier.

11. The system of claim 1, further comprising at least one dewatering screen configured to receive discharge from the at least one hydraulic classifier and configured to obtain the cleaned and reclaimed sand from the discharge from the at least one hydraulic classifier.

12. The system of claim 1, further comprising at least one debris screen or debris grate positioned between the manure source and the at least one pump for removing large or coarse debris from the mixture of manure, sand, and debris prior to passing the mixture through the at least one pump and to the at least one hydrocyclone.

13. The system of claim 1, further comprising at least one flow control valve configured to provide processing water for mixing with the mixture of manure, sand, and debris before the mixture is provided to the at least one pump so that the mixture can be pumped efficiently through the at least one pump and to the at least one hydrocyclone.

14. The system of claim 1, further comprising a processing water source configured to inject processing water through an inlet to a chamber of the at least one hydraulic classifier,
at least one flow control valve configured to control a flow rate for the processing water to the chamber, and
at least one system controller configured to operate the at least one flow control valve.

15. The system of claim 1, further comprising at least one pressure sensor configured to measure fluid pressure of the mixture at one or more of the following locations of the system:
an inflow of the at least one hydrocyclone;
an upper location of the at least one hydraulic classifier proximate to an inlet of the at least one hydraulic classifier;
a lower location of the at least one hydraulic classifier proximate to a fluidized bed of the at least one hydraulic classifier; or
an inflow of the at least one pump.

16. The system of claim 15, further comprising at least one flow control valve for limiting flow of the mixture through the system, and at least one system controller in communication with the at least one pressure sensor and the at least one flow control valve, wherein the at least one system controller is configured to:
receive pressure measurements for fluid in the system from the at least one pressure sensor; and
adjust fluid flow through the at least one flow control valve based, at least in part, of the received pressure measurements.

17. The system of claim 16, wherein the at least one flow control valve is positioned at one or more of the following locations:
between the manure source and the at least one pump;
at a discharge of the at least one hydraulic classifier; or
at a dewatering screen positioned to receive the mixture from the discharge of the at least one hydraulic classifier.

18. A system for cleaning and reclaiming sand, comprising:
at least one pump configured to receive a mixture of manure, sand, and debris from a source of manure;
at least one hydraulic classifier that receives the mixture from the at least one pump and processes the mixture for separating the sand from other portions of the mixture, thereby providing cleaned and reclaimed sand;
at least one pressure sensor configured to measure fluid pressure within a portion of the at least one hydraulic classifier;
at least one flow control valve configured to open and close for controlling flow of processing water into the at least one hydraulic classifier; and
at least one controller configured to receive pressure measurements from the at least one pressure sensor and control flow of the mixture through the at least one flow control valve based, at least in part, on the received pressure measurements.

19. The system of claim 18, wherein the at least one hydraulic classifier comprises a process water injection port configured for introducing the processing water below a fluidized bed of particles in the at least one hydraulic classifier causing upward rising current for separating larger and/or denser particles from smaller and/or less dense particles within the at least one hydraulic classifier, and
wherein adjusting a water injection rate through the process water injection port changes a target discharge size and/or density for the at least one hydraulic classifier.

20. A method for cleaning and reclaiming sand, comprising:
receiving a manure mixture comprising water, manure, sand, and debris from a livestock housing;
moving the received mixture to an inlet of at least one hydrocyclone using a pump, wherein the at least one hydrocyclone is configured for dewatering and separating particles of the mixture;
moving discharge from the at least one hydrocyclone to an inlet of at least one hydraulic classifier;
activating the at least one hydraulic classifier to separate sand of a target particle gravity, density, and/or size from other particles and/or debris of the mixture; and
moving a slurry comprising sand from the manure mixture to a dewatering screen for separating water from the slurry, thereby producing an amount of cleaned and reclaimed sand from the manure mixture.
